(19) United States
(12) Patent Application Publication
(10) Pub. No.: US 2008/0052111 A1
(43) Pub. Date: Feb. 28, 2008

(54) System and Method for Providing a Personal Health Summary

(76) Inventors: Leo McMenimen, Bethlehem, PA (US); John Silva, Succasunna, NJ (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/685,436

(22) Filed: Mar. 13, 2007

Related U.S. Application Data
(60) Provisional application No. 60/782,709, filed on Mar. 15, 2006.

(51) Int. Cl. G06Q 50/00

(52) U.S. Cl. 705/2

(57) ABSTRACT

A system and method provide consumer personal health summaries to consumers and medical professionals and includes receiving a set of search criteria; and retrieving one or more personal health summaries based on said set of search criteria, wherein the at least one personal health summary comprises claim data.

### CROSS-REFERENCE TO RELATED APPLICATION

The present invention claims priority to U.S. Provisional Patent Application No. 60/782,709, filed on Mar. 15, 2006, which is herein incorporated by reference in its entirety.

### FIELD OF THE INVENTION

The present invention relates to providing consumers and medical professionals with a way to be informed on the consumer's health by providing a method and system for providing a personal health summary.

### BACKGROUND

Electronic on-line access to consumer health information can be difficult and create problems for consumers, medical professionals and employers. Sometimes access to this information is not available. When access to health information is available, the information may be difficult to understand or may be presented in a non-user friendly format. For example, an interface providing health information may not present consumers and/or medical professionals with organized health information or with options to access health-related tools and/or information.

Therefore, there is a need for consumers to gain control over their data and insight into their personal health information in a manner consistent with their preferences and interests. In addition, medical professionals need a way to access consumer health information in an organized and meaningful way.

### SUMMARY

A system and method for providing a personal health summary enables consumers and medical professionals to be informed on the consumer's health status.

According to one implementation, a method for providing a personal health summary includes receiving a set of search criteria and retrieving one or more personal health summaries based on said set of search criteria, where at least one personal health summary includes claim data organized into one or more categories including conditions, prescriptions, procedures and lab tests.

According to an exemplary configuration, a system for providing a consumer healthcare guide includes data storage for storing consumer personal health data; and a processor for: receiving a set of search criteria; and retrieving consumer personal health summary data based on said set of search criteria, where the consumer personal health summary data includes claim data organized into one or more categories including conditions, prescriptions, procedures and lab tests.

In another implementation, a method for providing a personal health summary includes validating an identity of a consumer, and retrieving a consumer personal health summary, where the consumer personal health summary includes claim data organized into one or more categories including conditions, prescriptions, procedures and lab tests.

In another implementation, a method for providing a personal health summary includes providing a graphical user interface that enables a user to access data associated with a personal health summary, where the personal health summary data includes claim data associated with a consumer which is organized into one or more categories including conditions, prescriptions, procedures and lab tests.

The system and methods described above may provide consumers and medical professionals with a way to easily understand the health and/or well being of the consumer. By reviewing their personal health summary provided to them in accordance with embodiments of the invention, a consumer may be able to make informed choices related to their healthcare. Medical professionals may use the consumer personal health summary when deciding on treatments and/or may provide better care.

These and other features and advantages of the present invention will become apparent to those skilled in the art from the following detailed description, wherein it is shown and described illustrative implementations of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### DESCRIPTION OF THE DRAWINGS

FIG. 1A is a diagram of an exemplary system for providing a personal health summary.

FIG. 1B is a flowchart of a method for providing a personal health summary.

FIG. 1C is another flowchart of a method for providing a personal health summary.

FIG. 2A depicts an exemplary web interface configured for consumer access.

FIG. 2B depict another exemplary web interface configured for consumer access.

FIG. 2C depicts an exemplary display of a personal health summary.

FIG. 3A depicts an exemplary web interface configured for medical professional access.

FIGS. 3B-3D depict an exemplary web interface configured to provide medical professional access to a consumer's health summary.

FIG. 4A depicts an exemplary web interface configured for consumer self-reporting.

FIG. 4B depicts an exemplary web interface having self-reported consumer data.

FIG. 4C depicts an exemplary web interface configured for consumer self-reporting of allergies and immunizations.

FIG. 4D depicts an exemplary web interface configured for consumer self-reporting of family history information.

FIG. 4E depicts an exemplary web interface configured for consumer self-reporting of personal contact information.

FIG. 4F depicts an exemplary web interface configured for consumer self-reporting of health tracking information.

### DETAILED DESCRIPTION

A system and method for providing a personal health summary will now be described with reference to the accompanying drawings.

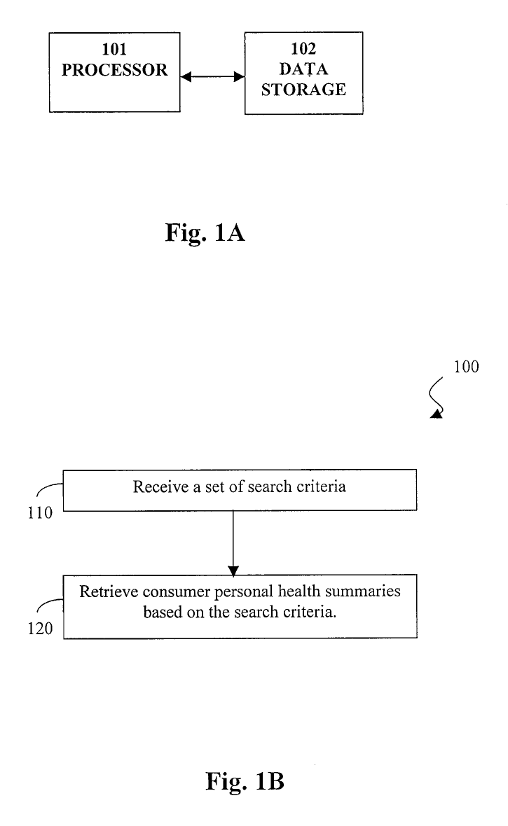

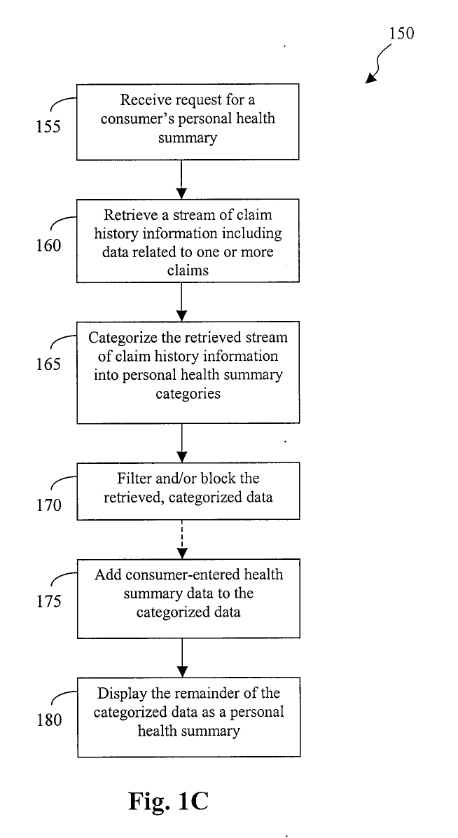

FIG. 1A is a diagram of an exemplary system for providing a personal health summary, e.g., a summary of a consumer's medical history using codes and descriptions used by doctors, hospitals, pharmacies and health insurance companies. The exemplary system includes a processor 101 and data storage 102. The processor 101 is configured to receive search criteria, and retrieve one or more personal health summary listings based on the search criteria. Data storage 102 is configured for storing personal health summary data and is communicatively coupled to the processor 101 to enable the processor to retrieve personal health summary data. Personal health summary data may include condition listings, e.g., primary and secondary diagnoses, prescription information, and procedure and lab test histories, which may be gathered from medical, pharmacy and lab claims. In addition, personal health summary data is updated periodically from various sources. For example, new/updated claim data, insurance information and/or consumer-entered data may be periodically provided to data storage 102. Furthermore, a graphical user interface or other user interface may be provided that is communicatively coupled with processor 101 and/or storage 102 for facilitating user access to information associated with the consumer's personal health summary. According to some embodiments, the consumer's personal health summary is provided to the consumer by browser technology, such as an Internet or intranet browser. A graphical user interface provided via the browser technology may enable a user to access their personal health summary from their home computer and view the health summary in a user-friendly format.

FIG. 1B is a flowchart of a method 100 for providing a personal health summary. Method 100 includes receiving 110 search criteria, and retrieving 120 one or more personal health summary listings based on the search criteria. Search criteria may be entered by a consumer, such as a member of an insurance plan, or by a medical professional or facility administrator. Search criteria may include data such as the consumer's name, group number, subscriber ID and/or date of birth. In another implementation, after a consumer has logged into a website configured to retrieve the consumer's personal health summary, the consumer may only need to select an icon or button on the website to retrieve the appropriate personal health summary. Alternatively, search criteria may be automatically entered when a user accesses an identification device. For example, by swiping a medical ID card, an insurance card, a combined medical ID/insurance/smart card, or by passing another personal device having embedded consumer identification information over or through a reader, the user's information may be received by the system and a personal health summary retrieved.

In a further example, a user may enter search criteria directed towards particular aspects of a consumer's personal health summary, such as a consumer's prescription history. The data subsequently retrieved may be limited to the consumer's prescription history, for example. Alternatively, a partial personal health summary may be presented along with links allowing the user to review the personal health summary in further detail so that a complete personal health summary is be presented to the user.

FIG. 1C is another flowchart of a method 150 for providing a personal health summary. Method 150 includes receiving 155 a request for a consumer's personal health summary, and in response, a stream of claim history information related to one or more claims is retrieved 160. The retrieved stream of claim history information is categorized 165, e.g., into condition, medication, procedure, and lab result categories. The retrieved, categorized data is filtered and/or blocked 170 using predetermined criteria, e.g., sensitive data and/or financial data may be filtered as a standard procedure and/or consumer groups may be blocked upon employer request. In some configurations, consumer-entered health summary data may optionally be added 175 to the categorized data. The resulting categorized data is displayed 180 as a personal health summary.

Data provided in a consumer's personal health summary may be associated with various aspects of the consumer and may include: consumer demographic information, conditions, prescriptions, procedures and/or lab tests.

Condition information in the consumer personal health summary may be provided when an abnormality in the physical status of the body as a whole or one of its parts is documented. The condition may be characterized by co-morbidities, which entail describing the condition with multiple diagnoses. In this case, a primary diagnosis may be provided, which is the main diagnosis responsible for the medical services provided for the condition; and a secondary diagnosis may be provided, which is the next main diagnosis responsible for the medical services provided for the condition. The one or more diagnoses may be represented by diagnosis codes, e.g., ICD code, and/or by diagnosis descriptions. The date on which the condition was first diagnosed and the date on which the condition was most recently diagnosed may also be provided, along with the diagnosing medical professional's name, practice group and/or facility.

Prescription information in the consumer personal health summary may be provided when physician-prescribed prescription-only medications have been documented. The prescription information may include the drug trade name, generic name, dosage, refills prescribed, days supplied per refill, the date the prescription was first filled and last filled, and the number of times the prescription has been dispensed to date.

Procedure information summarized in the personal health summary may be provided when a medical, surgical, or diagnostic treatment or operation is documented. The procedure may be provided by CPT code and by the code's description of the procedure. Where the procedure description is difficult to understand, the description may be modified to make it user-friendly. The name of the provider performing the procedure and the date the procedure was first performed and last performed may also be provided. In certain implementations, routine office visits are included in the procedure summary portion, and in alternative implementations, routine office visits are excluded.

Lab test data provided in the personal health summary may be provided when laboratory claim data is documented. The lab test information may include identification of the lab test performed, such as by LOINC (Logical Observation Identifiers Names and Codes), which are universal identifiers for laboratory and other clinical observations. A reference interval may also be provided, which is the range of values that covers 95% of the values of the healthy general population or of specific subpopulations differing in age and sex, along with measured data, e.g., the specific extent or quantity of a substance for which the test is preformed, the unit of measure and the date the test was performed.

In addition or alternatively, a consumer's family history and/or allergy and immunization information may be included in a personal health summary. It will be understood that various types on information may be provided in a consumer's personal health summary in addition or as an alternative to those described above.

In some configurations, some portion of a consumer's health summary information may be suppressed due to the presence of sensitive diagnoses, e.g., HIV, substance abuse and mental disorders may be suppressed. Consumer information suppressed from personal health summaries may also be the result of standard policies, e.g., financial data, standard office visits and/or blood tests may not included in any personal health summaries. Further, the consumer may not have data associated with one or more aspects of the personal health summary. In these cases, the corresponding personal health summary portion may be left blank.

Consumer personal health summary data may also be blocked, for example upon an employer request to block certain employee/consumer groups. The consumer may also block data, for example, so that personal health summary data related to other family members is not accessible or so that certain categories of the personal health summary are not accessible. In a further embodiment, a consumer may opt out of using the personal health summary tool partially or completely. For example, a partial opt out may block medical professionals from viewing a consumer's personal health summary, while continuing to allow the consumer to access their personal health summary. If a consumer elects to fully opt out of the option to use the health summary tool, the consumer and medical professionals would not have access to the tool.

In particular configurations, financial data related to claims, deductibles, e.g., in network and out of network, and copays may be provided as part of a consumer's personal health summary.

In further configurations, a consumer may add self-reported data to their personal health summary. For example, the consumer may add comments related to a previously diagnosed condition in the condition section of their personal health summary. In another example, a consumer may add self-reported data related to sections related to their family history, allergies, immunizations and/or personal contacts. Consumers may also add self-reported data to wellness and/or clinical tools. Self-reported data added to a wellness tool may include caloric intake, weight, daily drinks and/or hours of sleep. Self-reported clinical data may include blood pressure, blood sugar, hemoglobin, total cholesterol, HDL and LDL cholesterol, and triglycerides. According to these configurations, subsequently retrieved consumer health summaries include the self-reported data and may include data generated from an analysis of the self-reported data. Alternatively, the consumer may elect to block their self-reported data when their personal health summary is accessed by a medical professional. In addition, in some configurations, the consumer may be able to edit and/or delete self-reported data.

In addition, a consumer may customize portion(s) of their personal health summary displayed. For example, a consumer may select the web interface so that prescription information is listed at the beginning of their personal health summary. A consumer may also choose that a health-tracking web interface first be presented to the user in order to review and enter self-reported health tracking data. In another example, health tracking information and prescription information may be displayed together.

The data presented in a personal health summary may be based on a time window, such as a time window of 1 month, 6 months, 1 year, 2 years or 3 years, 2 years from a consumer's last submitted claim, or any time window suitable to provide a consumer and/or medical professionals with useful health summary information. Alternatively, the time window may be a dynamic time window based on the consumer data, e.g., claim data, available for a given time range. For example, if the consumer has claim data available for a 6-month period, this should be the time range displayed.

The personal health summary data may be retrieved and reviewed via the Internet, such as from an insurance plan-sponsored website. A user may also be presented with an option to print the consumer's personal health summary. This may be useful for a consumer when visiting a new doctor, or in order to carry a copy when traveling. Additionally or alternatively, a user may request that the personal health summary be stored on a personal computing device, mailed or sent via email to the consumer's and/or a medical professional's email. In some configurations, a medical professional may access a consumer's personal health summary via a provider portal, for example, when the consumer is present at a medical appointment. This may be useful when a medical professional has questions related to conditions, medications, procedures and/or tests related to the consumer.

The personal health summary data may be provided in varying formats depending on the user retrieving the personal health summary. For example, a consumer may be presented with a basic personal health summary providing a listing of the conditions, medications, procedures and lab tests, along with general statements related to each of the categories and comments added by the consumer, if available. A medical professional may be presented with a more detailed personal health summary for a consumer, which may include a listing of codes and code descriptions associated with the consumer conditions, medications, procedures and lab tests.

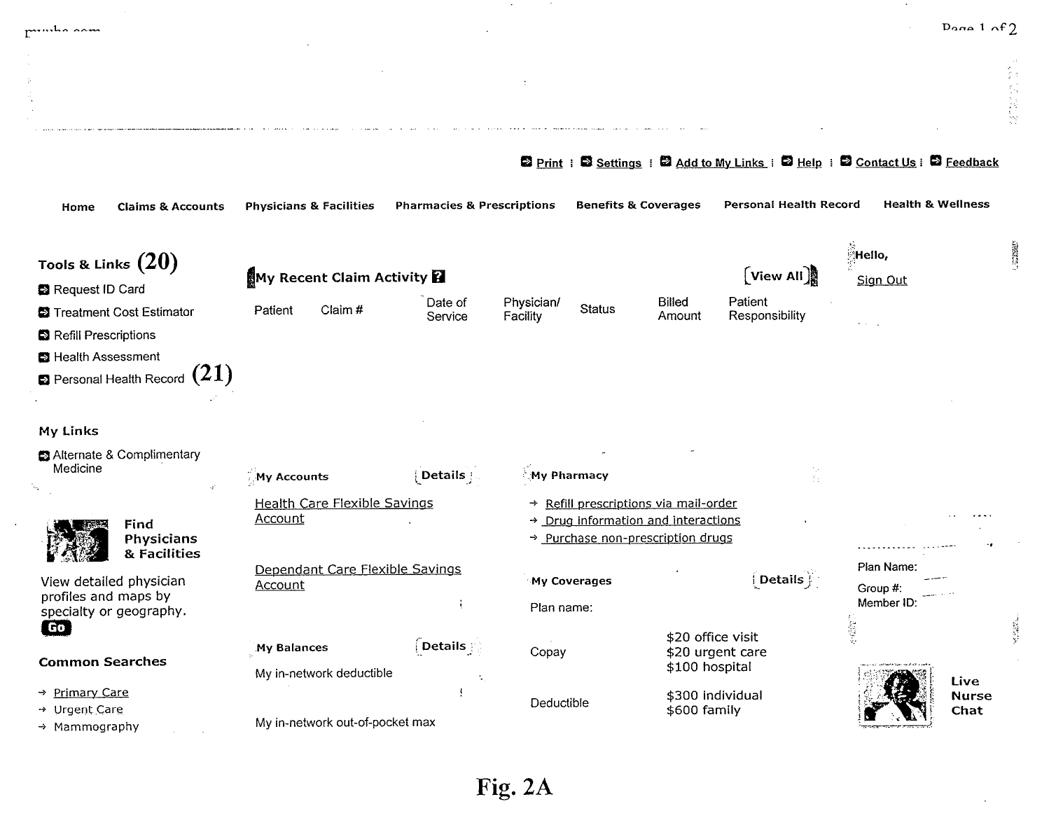

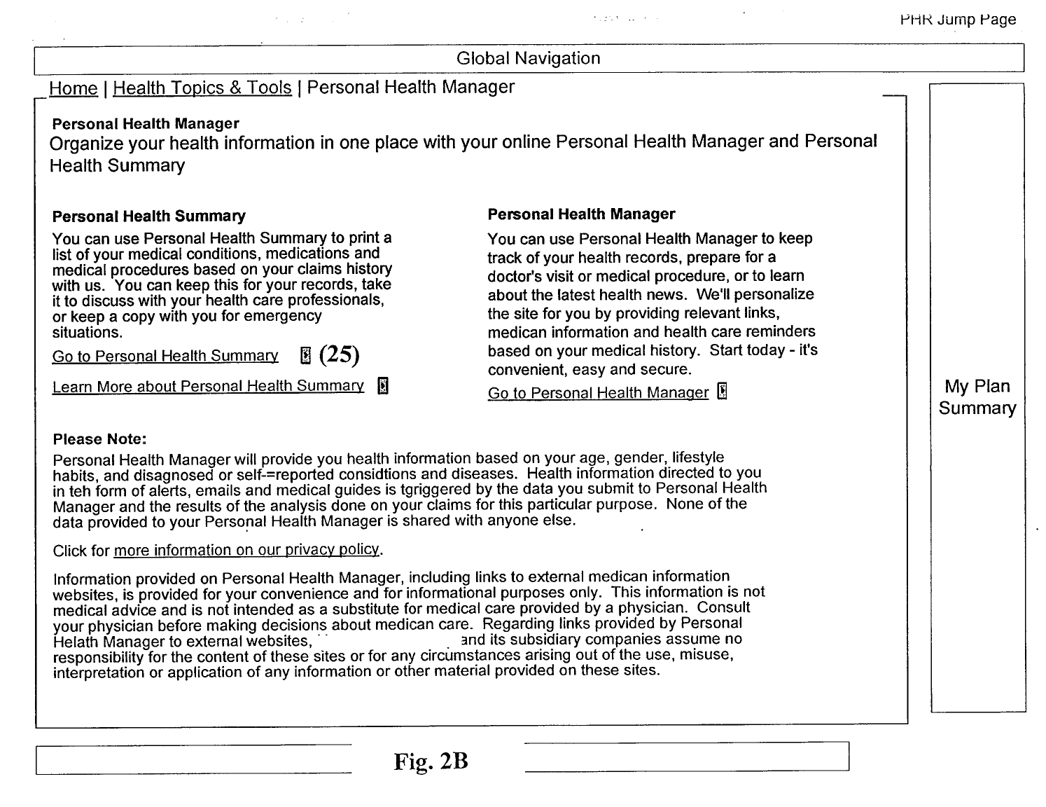

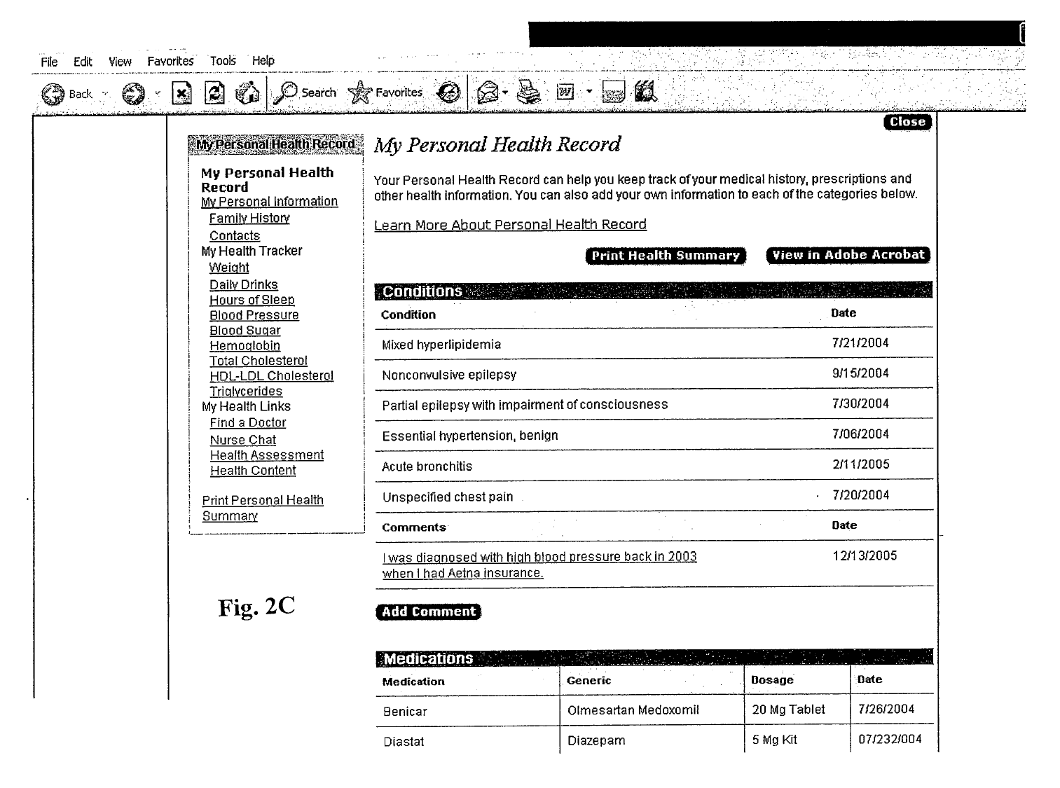

Consumer personal health summaries may be provided in a variety of mediums including on a graphical user interface (GUI), such as a web interface. In exemplary configurations, depicted in FIGS. 2A-4F, personal health summaries are provided on web interfaces or via web interface links. Data has been redacted as appropriate to protect the privacy interests of providers and facilities.

FIG. 2A depicts a web interface configured for consumer access. For example, a consumer may access the web interface of FIG. 2 by verifying their enrollment in a healthcare plan that supports the web interface. The consumer may select from a variety of links on the web interface of FIG. 2, including tools and links (20) such as a personal health record link (21). Providing a web interface such as the one depicted in FIG. 2A enables an insurance company, for example, to align their healthcare support services while enabling easy consumer access. For example, when a consumer has a question regarding their health history, they may select the personal health record link (21) and be presented with a summary of their medical history for review.

FIG. 2B depicts another web interface configured for consumer access that allows a user to access their personal health summary by selecting the “Go to Personal Health Summary” link (25).

FIG. 2C provides an exemplary display of a personal health summary which may be displayed upon selecting a personal health summary link provided on various web interface screens, such as the web interface screens depicted in FIGS. 2A and 2B. FIG. 2C depicts a web interface related to a consumer's personal health summary that includes condition and medication data, but which excludes cost data such as claim information and deductible amounts. However, in some configurations, the consumer's personal health summary may include cost data. This may be useful when the consumer is interested in understanding financial aspects related to their healthcare.

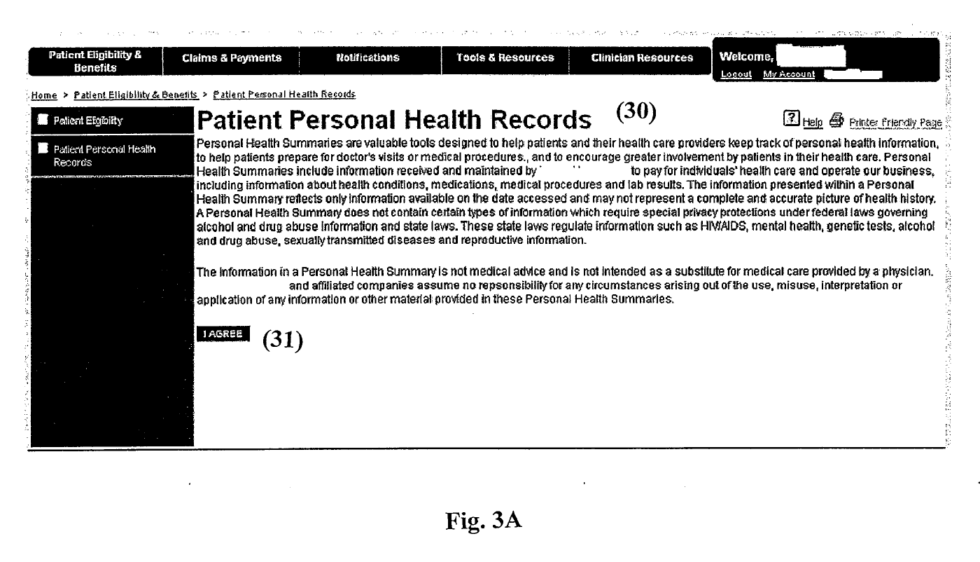

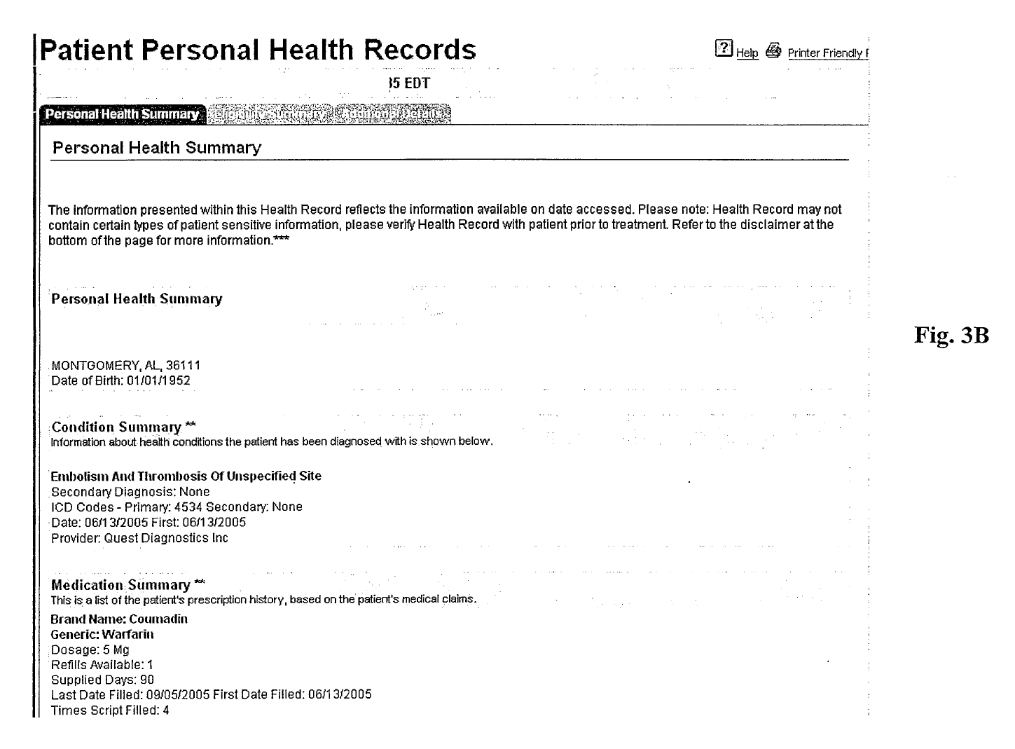

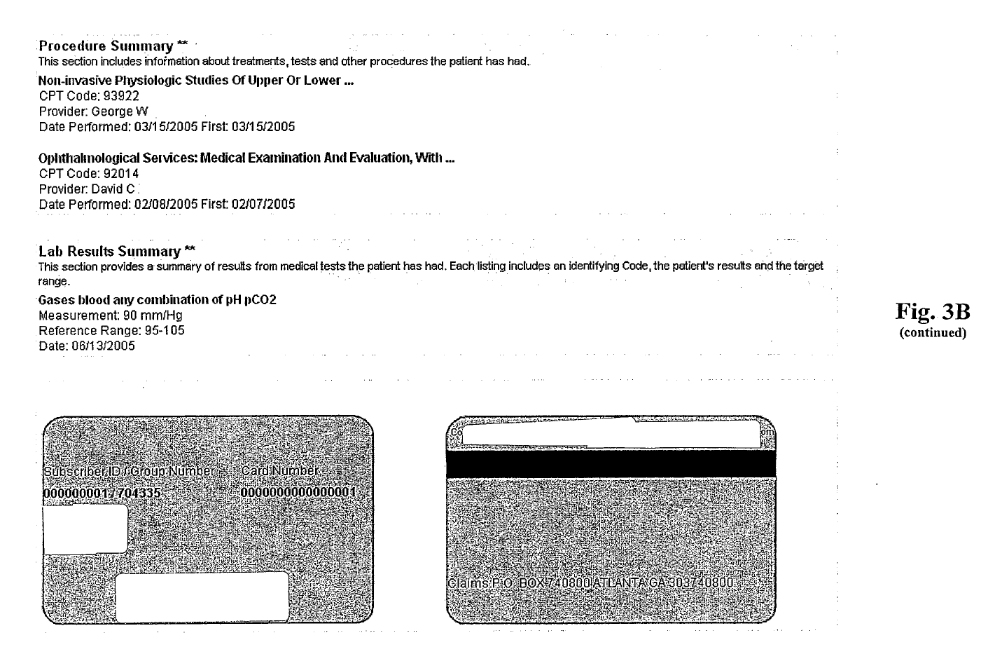

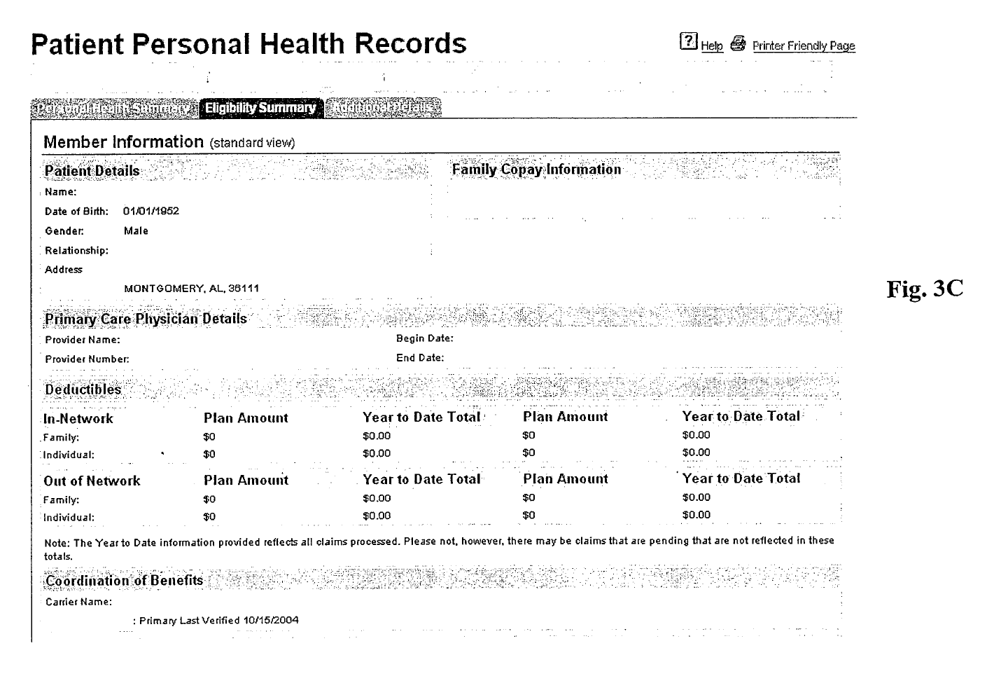

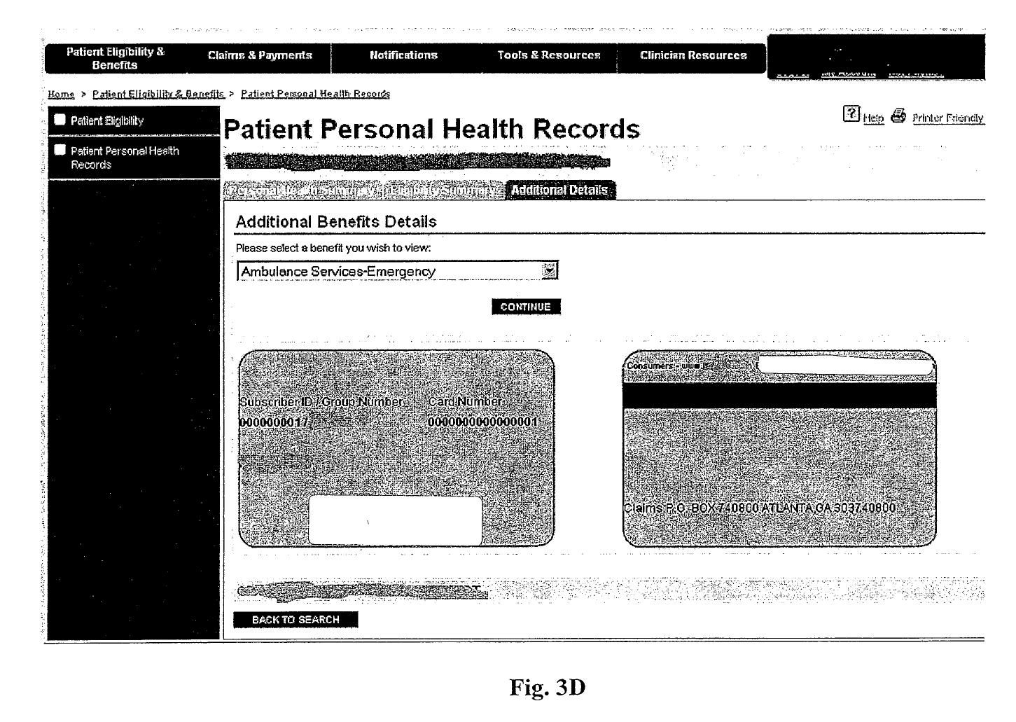

FIG. 3A depicts a web interface configured to provide medical professionals access to consumer personal health summaries via a “Patient Personal Health Records” tool. According to FIG. 3A, a medical professional reviews the terms and conditions (30) for using the tool and selects an “I Agree” icon (31), wherein upon selection, a tab showing a consumer personal health summary is provided on the web interface for the medical professional to review.

FIG. 3B is an exemplary web interface that depicts a personal health summary tab in a patient personal health records tool configured for review by a medical professional. According to FIG. 3B, the personal health summary includes data related to a consumer's identity, place of residence and date of birth, and a summary of the identified consumer's health history, which is provided in categories entitled condition summary, medication summary (3B), procedure summary and lab results summary (3B continued).

FIG. 3C is an exemplary web interface that depicts an eligibility summary tab related to an identified consumer that is configured for review by a medical professional. The eligibility summary tab provides a medical professional with details on the consumer's demographics, primary care physician, deductibles, and coordination of benefits. The eligibility summary tab may be useful when a medical professional has a question regarding the consumer's primary care physician, for example.

FIG. 3D provides an additional details tab, which may also be provided to a medical professional for review. The additional details tab may provide information such as consumer self-reported data, past and future appointment information related to the consumer and/or additional benefit information. According to FIG. 3D, the medical professional may select a benefit provided in a pull-down menu in order to view the consumer's benefits associated with the benefit.

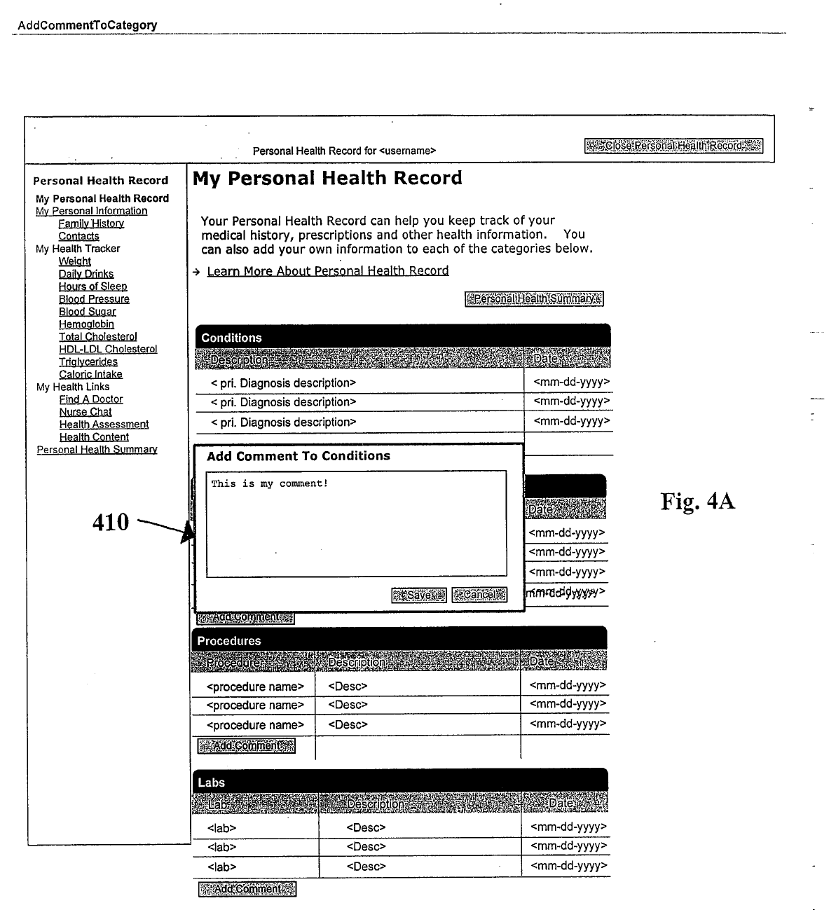

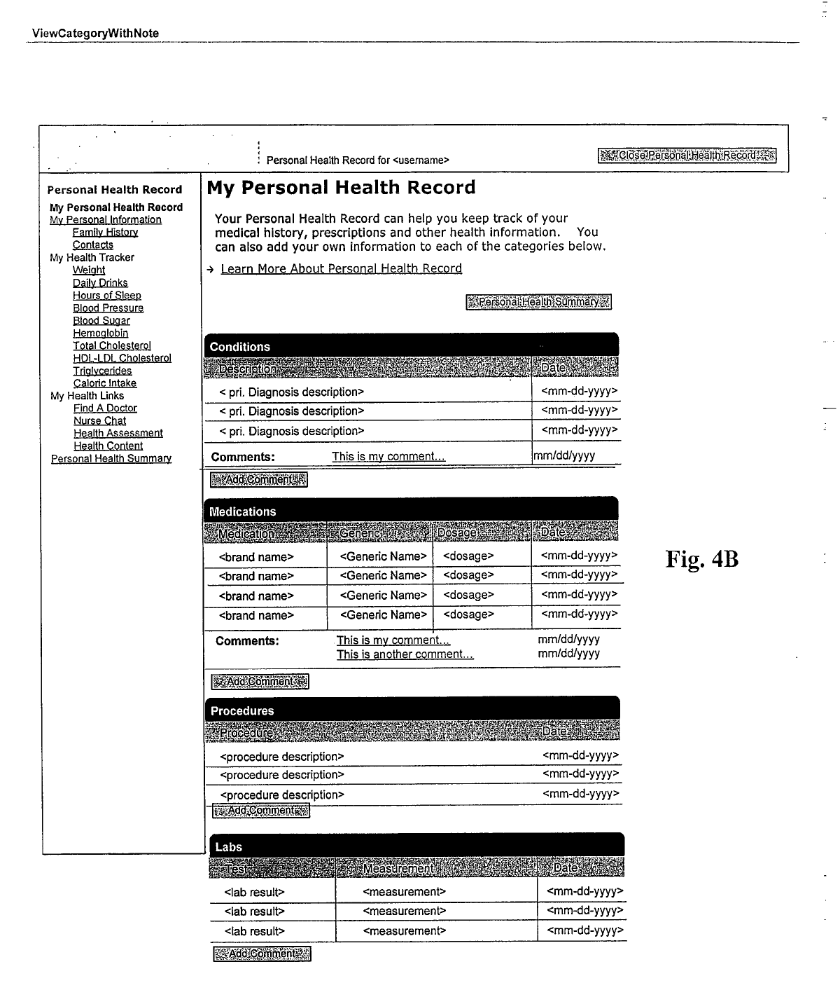

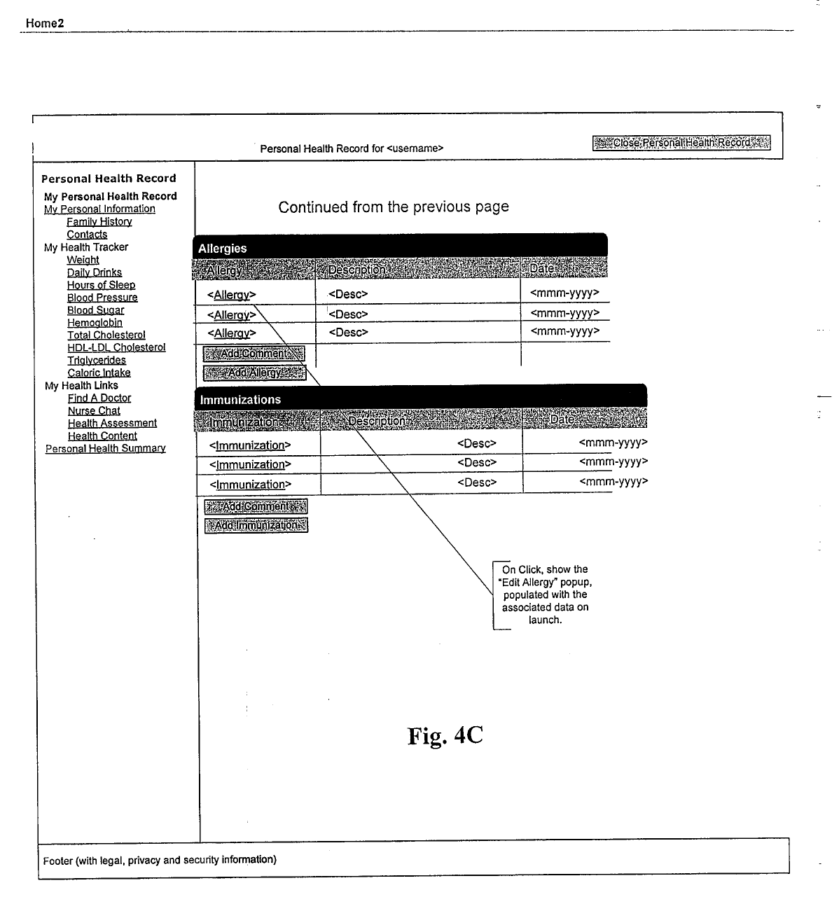

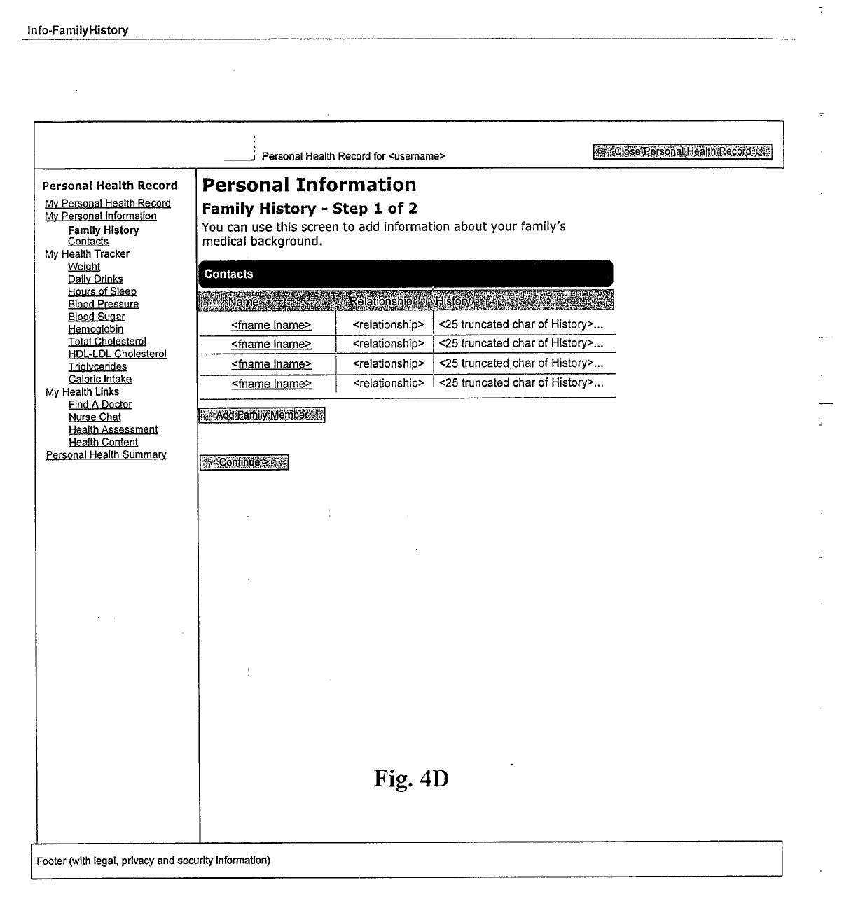

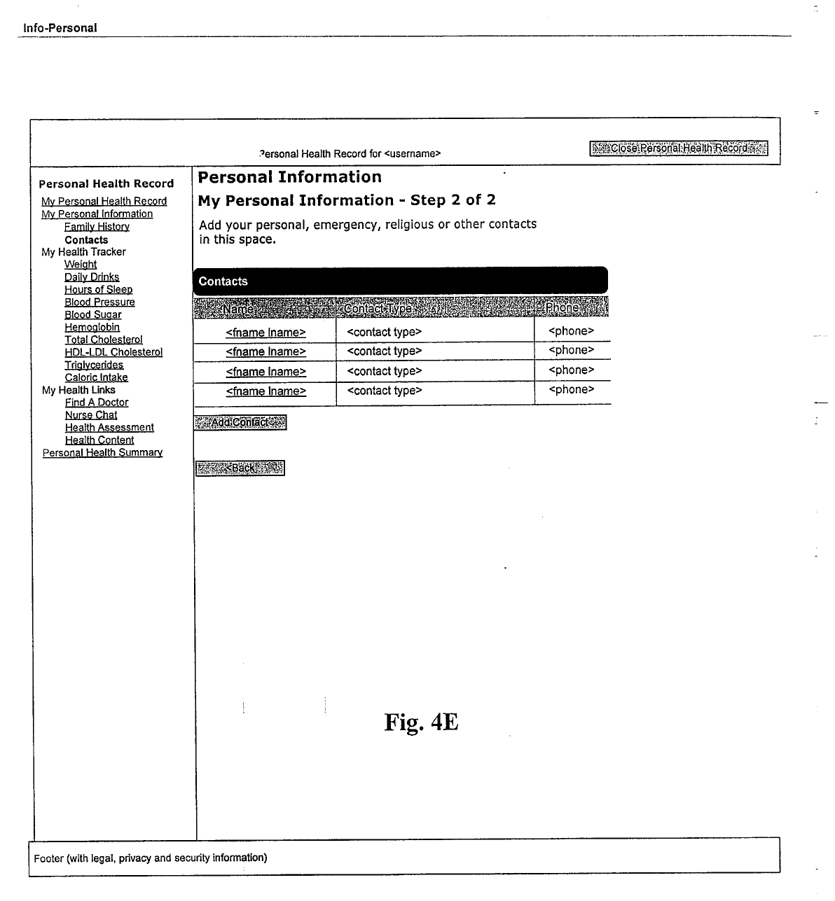

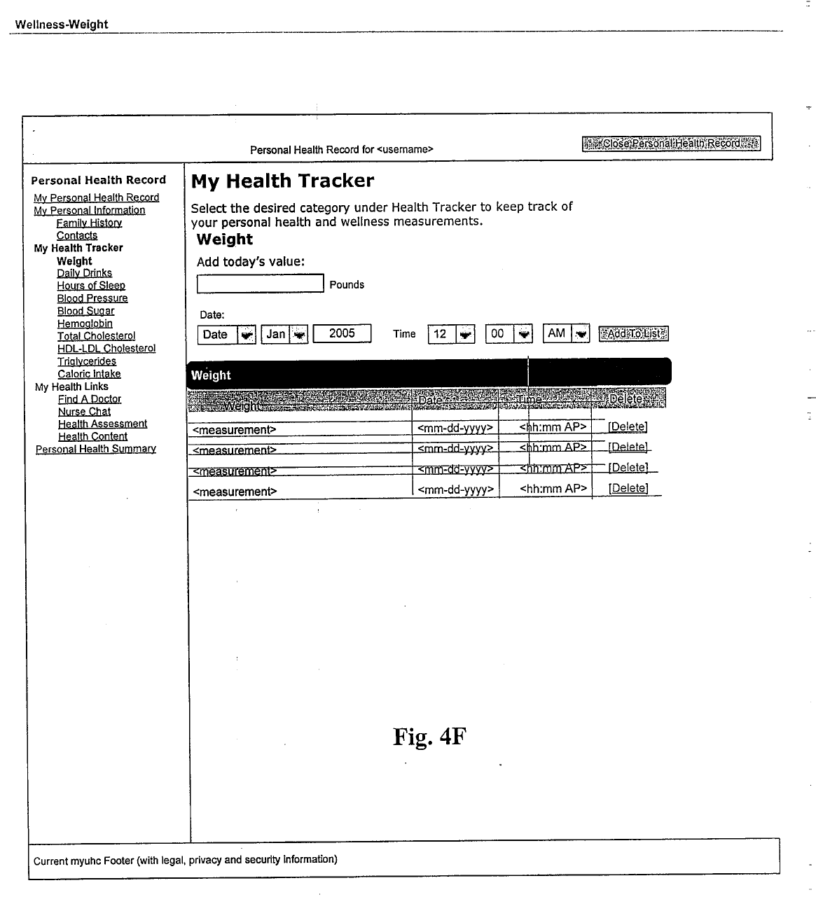

FIG. 4A depicts an exemplary web interface configured for consumer self-reporting. Self-reported data may be entered in various portions the consumer's personal health record by selecting “Add Comment” in the desired portion of the personal health record. In FIG. 4A, a consumer has selected “Add Comment” under the conditions portion of the personal health record and a text box 410 is provided for a consumer to enter comments related to a medical condition. Once the consumer selects “save” on the text box 410, the self-reported data is saved and displayed in the comments section of the consumer's condition portion of their personal health record as seen in FIG. 4B.

FIG. 4C depicts an exemplary web interface configured for consumer self-reporting of allergies and immunizations. According to FIG. 4C, a consumer may report allergies and/or immunizations as well as comments related to the allergies and/or immunizations.

FIG. 4D depicts an exemplary web interface configured for consumer self-reporting of family history information. In this section of a consumer's personal health record, a consumer may enter information such as a family member's name, the relationship of the family member to the consumer, and a brief description of their medical background.

FIG. 4E depicts an exemplary web interface configured for consumer self-reporting of personal contact information. In this personal information section of a consumer's personal health record, a consumer may enter personal and emergency contacts and their phone number(s).

FIG. 4F depicts an exemplary web interface configured for consumer self-reporting of health tracking information. In the particular web interface of FIG. 4F, the consumer may ender their current weight, and the date and time of their entry. The data entered in the weight tracking web interface may be used alone or along with other wellness information in order to track a consumer's personal health.

The above-described web interfaces may further include links to various tools that may provide the consumer and/or medical professional with further information relevant to the consumer. In some embodiments, consumer links may be provided for interactive tools that give the consumer insight regarding the impact of a healthy and/or unhealthy lifestyle decisions and/or treatment decisions. A link may be provided for an online assessment tool that assesses a consumer's personal health summary and in some instances their family history, and provides health risk assessment information. Another link may enable a consumer to access a provider lookup tool, for example in order to find a physician within their healthcare network. Links to various Internet sites may also be provided for the consumer. For example, a link to a health forum Internet site may allow a consumer to lookup definitions and/or explanations on health topics. Alternatively, a consumer may lookup definitions and/or explanations within the system providing the personal health summary. Other links that may be provided to a consumer include a nurse chat links, which allows a consumer to immediately communicate with a nurse online, links providing guidance for preparing for an appointment with a medical professional, links directing the consumer to a chat site for communicating with other users regarding certain health topics, links for accessing clinical trials, community resources, pharmaceutical information and/or consumer health-related calendars.

Medical professional web links may be provided with a consumer personal health summary listing and may include links for accessing pertinent consumer data and/or avenues for consumer intervention, outreach and/or follow-up.

In some configurations, the system associated with providing a personal health summary may also include capabilities to send reminders and/or notifications to consumers and/or medical professionals. For example, the system may send a reminder email to a consumer when due for a check-up or to remind the consumer of a scheduled visit to a medical professional. Messages may also be sent to a medical professional to notify the medical professional of a consumer's personal health record.

The method and system according to the present invention may be implemented using various combinations of software and hardware as would be apparent to those of skill in the art and as desired by the user. The present invention may be implemented in conjunction with a general purpose or dedicated computer system having a processor and memory components.

From the above description and drawings, it will be understood by those of ordinary skill in the art that the particular implementations shown and described are for purposes of illustration only and are not intended to limit the scope of the present invention. Those of ordinary skill in the art will recognize that the present invention may be embodied in other specific forms without departing from its spirit or essential characteristics. References to details of particular implementations are not intended to limit the scope of the invention.

What is claimed is:

1. A method for providing a personal health summary comprising:
receiving a set of search criteria; and
retrieving one or more personal health summaries based on said set of search criteria, wherein the at least one personal health summary comprises claim data organized into one or more categories comprising conditions, prescriptions, procedures and lab tests.

2. The method of claim 1, wherein the retrieved personal health summary is provided by browser technology.

3. The method of claim 1, wherein the claim data is associated with a window of time.

4. The method of claim 3, wherein the window of time is a dynamic time window.

5. The method of claim 1, wherein retrieving further comprises filtering the retrieved claim data.

6. The method of claim 5, wherein filtering comprises filtering out financial data related to the retrieved claim data.

7. The method of claim 5, wherein filtering comprises filtering out one or more predetermined conditions in the retrieved claim data.

8. The method of claim 1, wherein retrieving further comprises blocking all or a portion of the retrieved claim data.

9. The method of claim 8, wherein blocking comprises blocking claim data based on an employer request.

10. The method of claim 1, wherein retrieving further comprises retrieving self-reported data.

11. The method of claim 1, further comprising displaying the at least one retrieved personal health summary.

12. The method of claim 11, wherein displaying comprises displaying a plurality of health summary categories.

13. The method of claim 11, wherein displaying comprises displaying the at least one retrieved personal health summary in a consumer-friendly format.

14. The method of claim 11, wherein displaying comprises displaying in a medical professional-friendly format.

15. The method of claim 1, further comprising validating an identity of a consumer, and wherein retrieving the one or more personal health summaries comprises retrieving a consumer personal health summary.

16. The method of claim 1, further comprising validating an identity of a medical professional, and wherein receiving the set of search criteria comprises receiving a set of search criteria from the validated medical professional.

17. A system for providing a consumer personal health summary comprising:
data storage for storing consumer personal health data; and
a processor for:
receiving a set of search criteria; and
retrieving consumer personal health summary data based on said set of search criteria, wherein the consumer personal health summary data comprises claim data organized into one or more categories comprising conditions, prescriptions, procedures and lab tests.

18. The system of claim 17, wherein the claim data comprises at least one of medical, pharmaceutical and lab test claim data.

19. The system of claim 17, further comprising a graphical user interface for displaying the retrieved consumer personal health data.

20. A method for providing a personal health summary comprising:
validating an identity of a consumer; and
retrieving a consumer personal health summary, wherein the consumer personal health summary comprises claim data organized into one or more categories comprising conditions, prescriptions, procedures and lab tests.

21. A method for providing a personal health summary comprising:
providing a graphical user interface that enables a user to access data associated with a personal health summary, wherein the personal health summary data comprises claim data associated with a consumer, the claim data organized into one or more categories comprising conditions, prescriptions, procedures and lab tests.
